(19) United States
(12) Patent Application Publication
(10) Pub. No.: US 2012/0288251 A1
(43) Pub. Date: Nov. 15, 2012

(54) SYSTEMS AND METHODS FOR UTILIZING OBJECT DETECTION TO ADAPTIVELY ADJUST CONTROLS

(75) Inventors: Chung-Yi Weng, Taichung City (TW); Ho Chao Huang, New Taipei City (TW)

(73) Assignee: CYBERLINK CORP., Taipei (TW)

(21) Appl. No.: 13/107,224

(22) Filed: May 13, 2011

(51) Int. Cl. H04N 5/77

(52) U.S. Cl. 386/224; 386/E05.069

(57) ABSTRACT

Various systems and methods are described. One embodiment is a method performed in a multimedia playback system for adaptively modifying a user interface. The method comprises receiving, by the multimedia playback system, multimedia content and displaying the multimedia content; and generating, by a user interface generator, one or more controls displayed in conjunction with the multimedia content. The method further comprises identifying, by an object detector, one or more objects in a field of view of a video capture device coupled to the multimedia playback system; determining, by a control detector, a relative position of the one or more controls with respect to the one or more objects; and adjusting, by the user interface generator, the one or more controls according to a location of the one or more objects with respect to the video capture device.

### TECHNICAL FIELD

The present disclosure generally relates to utilizing object detection and facial detection results to adjust a user interface.

### BACKGROUND

Various playback systems are available that offer users the ability to control playback via virtual onscreen controls. The virtual controls comprise such basic commands as stop, play, skip forward, and so on. Today, flat panel televisions are commonly available in sizes that provide for larger viewing distances. As the size of displays increases, the placement of controls becomes even more important. For example, placing a set of virtual controls on the lower left hand corner of a large display to control content displayed on the upper right hand corner of the display can be inconvenient for the viewer to control playback, particularly as the viewer moves. In this regard, one perceived shortcoming with current systems that deploy such onscreen virtual controls is that the viewer may move around. While the controls may initially be in close proximity to the user, the relative position of the controls with respect to the viewer changes as the viewer moves around. Significantly, the viewer must then figure out where the virtual cursor is with respect to the controls by, for example, waving his hand to determine the relative location of the controls.

### SUMMARY

One embodiment is a method performed in a multimedia playback system for adaptively modifying a user interface. The method comprises receiving, by the multimedia playback system, multimedia content and displaying the multimedia content; and generating, by a user interface generator, one or more controls displayed in conjunction with the multimedia content. The method further comprises identifying, by an object detector, one or more objects in a field of view of a video capture device coupled to the multimedia playback system; determining, by a control detector, a relative position of the one or more controls with respect to the one or more objects; and adjusting, by the user interface generator, the one or more controls according to a location of the one or more objects with respect to the video capture device.

Another embodiment is a multimedia playback system configured to adaptively modify a user interface. The system comprises a user interface generator configured to generate one or more controls displayed in conjunction with a multimedia content displayed by the multimedia playback system; and an object detector configured to identify an object of the multimedia playback system, the object being in a field of view of a video capture device coupled to the multimedia playback system. The system further comprises a control detector configured to determine a relative position of the one or more controls with respect to the one or more objects, wherein the user interface generator adjusts the one or more controls according to a location of the object with respect to the video capture device.

Another embodiment is a method that comprises receiving, by the multimedia playback system, multimedia content and displaying the multimedia content; generating, by a user interface generator, playback controls displayed in conjunction with the multimedia content; and identifying, by an object detector, a user in a field of view of a video capture device coupled to the multimedia playback system. The method further comprises determining an initial relative position of the playback controls with respect to the user according to a first selection by the user of one of the playback controls; and adjusting the playback controls according to a location of the user with respect to the video capture device such that the initial relative position is maintained.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a multimedia playback system configured to adaptively modify a user interface.

FIG. 2 is an embodiment of the multimedia playback system of FIG. 1.

FIGS. 3A-B depict a method in accordance with an embodiment performed in the multimedia playback system of FIG. 1 for adaptively modifying a user interface.

FIG. 4 illustrates use of onscreen controls by a user of the multimedia playback system.

FIGS. 5-6 illustrate a perceived shortcoming associated with other multimedia playback systems.

FIG. 7-9 illustrate the adaptive modification of controls in accordance with various embodiments.

FIG. 10 illustrates the calculation of a relative distance between onscreen controls and the user.

FIG. 11 illustrates various means for calculating a relative distance between the onscreen controls and the user.

FIG. 12 is a method in accordance with an alternative embodiment performed in the multimedia playback system of FIG. 1 for adaptively modifying a user interface.

FIG. 13 is another method in accordance with an alternative embodiment performed in the multimedia playback system of FIG. 1 for adaptively modifying a user interface.

FIG. 14 illustrates the adaptive modification of controls based on motion in accordance with various embodiments.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

Embodiments are described for improving human-machine interaction by optimizing the placement of controls based on the location of a user. Note that in the context of this disclosure, the term “control” generally refers to any element or object in a user interface that may be manipulated or selected by a user to control playback or navigate through multimedia content shown on a display (for example, radio buttons, check boxes, sliders, icons, spinners, scrollbars, text boxes, and so on). For various embodiments, the placement of virtual controls is performed according to the detection of a user controlling playback of a video using onscreen controls. In this regard, virtual controls are adaptively placed proximal to the location of one or more users for optimum interaction with the system. In accordance with some embodiments, the facial region of the user is tracked. When a user moves, the virtual controls are moved in accordance with the user's movement so that the user does not need to re-calibrate and determine the location of particular controls as the relative location of the virtual controls with respect to the user remains substantially the same.

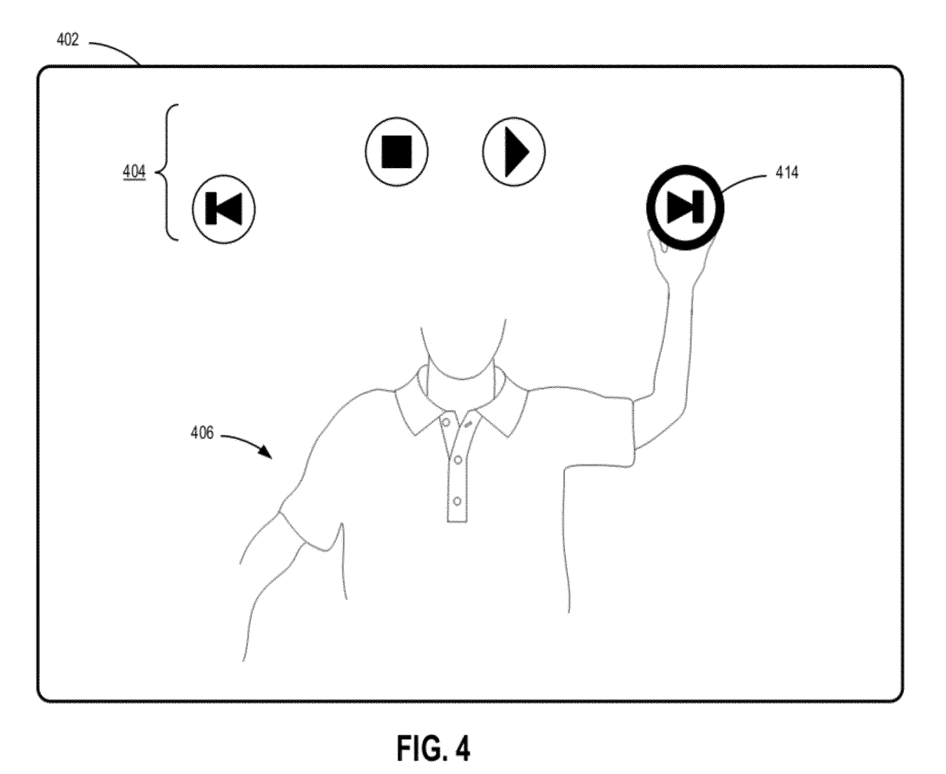

One application for the adaptive placement of controls as described herein is for playback of video content whereby a user interface for controlling playback of the video is shown on the display with the video. Note, however, that while various embodiments are described herein relating to the playback of video, the embodiments may also be applied to other applications such as playback of other multimedia content comprising images and slideshows. Generally, it is more inconvenient for a user to use a set of virtual controls that remain stationary with respect to the user as the user always knows the location of the virtual controls. Reference is made to FIG. 4. As shown in the example, various playback controls 404 are shown on a display area 402 that comprise a stop playback control, skip forward control, skip backward control, and a play control. The controls 404 are shown on the display area 402 while video content such as a movie is being played.

As described in more detail below, the motion of the user 406 is tracked. For example, if the user 406 elects to skip to the next chapter in the movie, the user 406 navigates the controls 404 by moving his hand over the skip forward control 414 and “clicks” on the skip forward control 414 by placing his hand over the location of the skip forward control 414 on the display. Note that for purposes of the illustrations described herein, the user 406 is shown in the display area 402. However, an image of the entire user 406 is typically not shown on the display area 402. Instead, only a portion of the user 406 such as the user's hand is shown on the display area 402. Alternatively, a cursor or pointer is shown on the display area 402 that corresponds to the user's location. The display area 402 shows the video content being played and the playback controls 404.

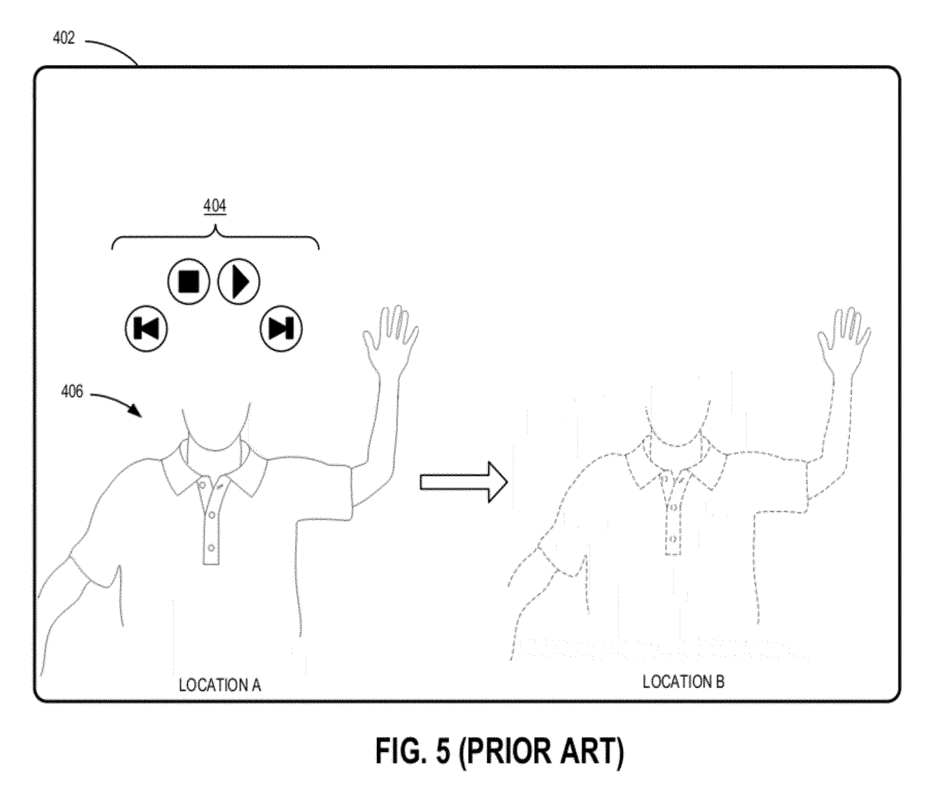

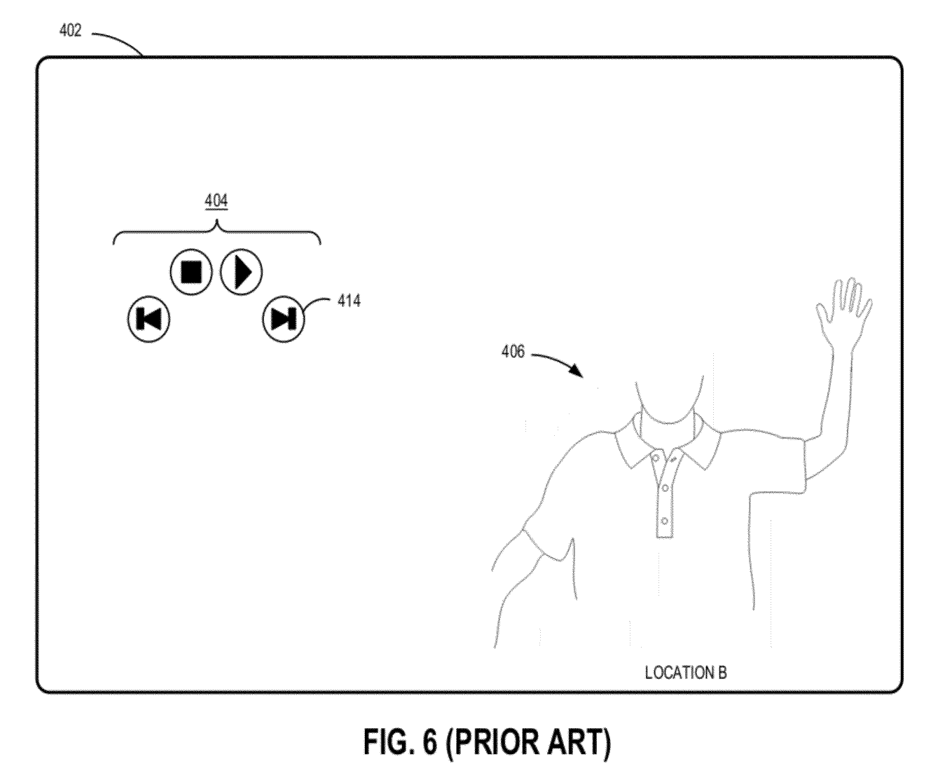

One perceived shortcoming with systems that deploy such onscreen controls 404 is that the user 406 viewing the video content may move around. Reference is made to FIG. 5. As shown, the user is initially at “Location A.” The playback controls 404 are shown in close proximity to the user 406. The location of the controls 404 may be situated in a predetermined location. For example, the controls 404 may be aligned to the top of the display area 402. One perceived shortcoming with the setup depicted in FIG. 5 is that if the user moves (i.e., to “Location B”), the controls 404 remain in the same location, as shown in FIG. 6. Significantly, the user 406 has to then wave his hand and determine the relative location of the controls 404. In this case, the user 406 either has to move back to his last position or reach up with his other hand to tap a control 404 (e.g., the skip forward control 414). This can be inconvenient for the user 406. Also, if the user moves farther away from the video capture device or closer to the video capture device, the controls 404 remain the same size.

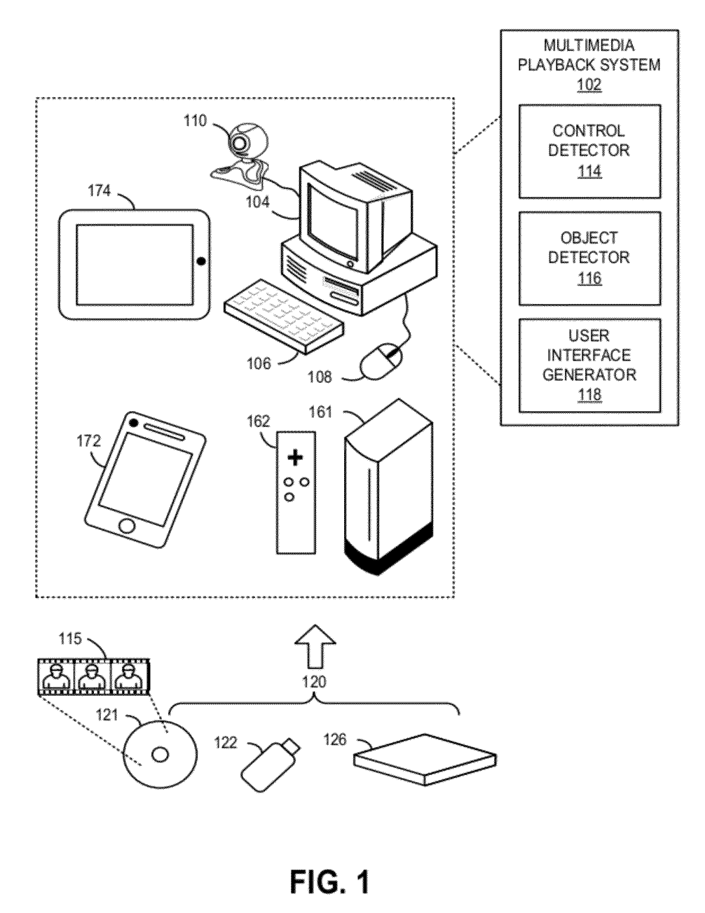

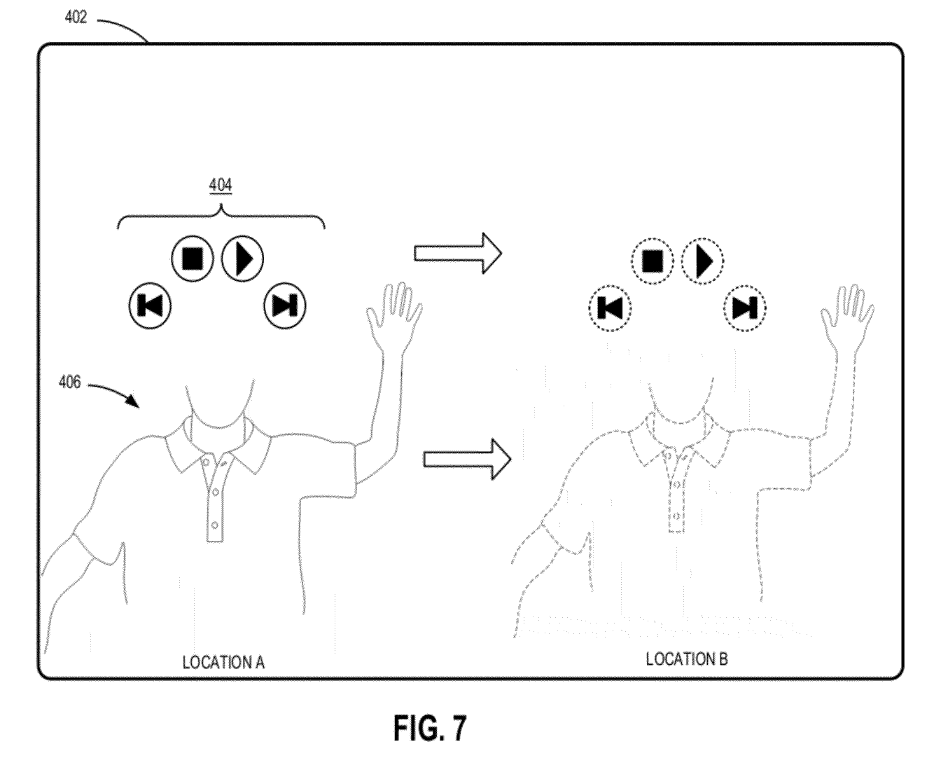

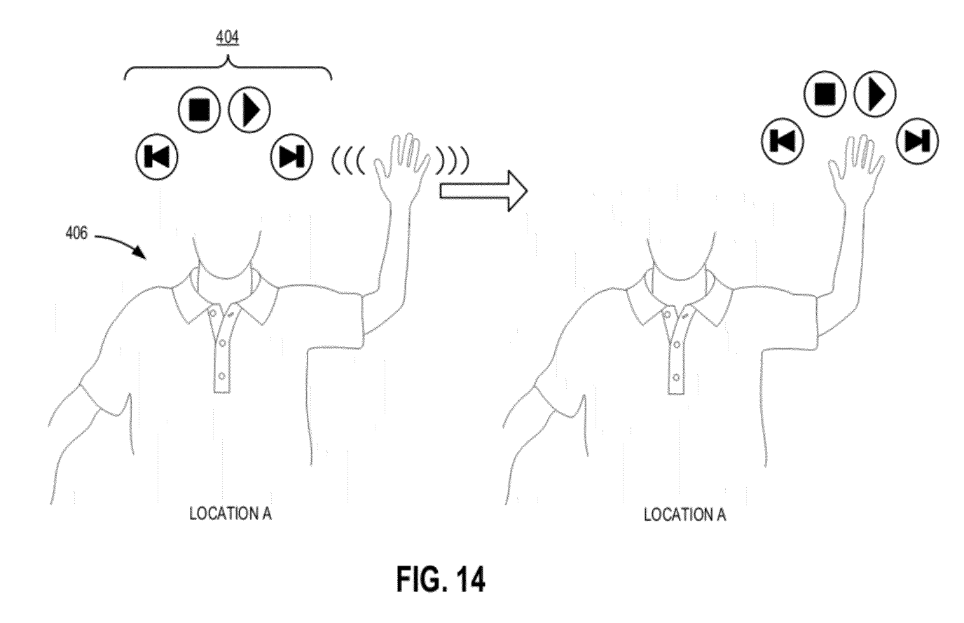

Various embodiments are described for the adaptive placement of playback controls based on the user's motion. In particular, the relative placement of the playback controls remains constant with respect to the user. Referring to FIG. 7, if the user 406 moves from “Location A” to “Location B,” the controls 404 move accordingly. Thus, the user 406 can always reach straight up to access certain controls (e.g., the stop or play controls) and right or left for the skip forward/backward controls, thereby making playback control more convenient. Note that the motion on the part of the user 406 can also comprise hand waving and/or motion by the user's 406 head and is not limited to motion as a whole by the user 406. To illustrate, reference is briefly made to FIG. 14, which shows the controls being adaptively adjusted according to a hand waving motion by the user 406. In this example, the user 406 remains stationary at “Location A” but waves his hand, thereby causing the controls 404 to be relocated in a location central to his hand for easy access. In some embodiments, the controls 404 can be adjusted to a location associated with one or more previously-identified objects if no objects are currently identified. Note that for some embodiments, the controls 404 are hidden from view if there is no motion on the part of the user 406 for a predetermined amount of time. For example, if the user 406 doesn't move at all for 5 seconds, the controls 404 can be temporarily hidden as the user may simply want to view the multimedia content. Similarly, if the object disappears or cannot be identified for a predetermined amount of time, the controls 404 are hidden from view. For example, this may be the result of the viewer moving outside the field of view of the video capture device 110 shown in FIG. 1. Note, however, that the predetermined amount of time will typically be greater than the predetermined amount of time required for a user to make a selection. The user makes a selection by holding his hand over the desired control 404 for a predetermined period of time so that the user does not inadvertently select a control by passing his hand over the control.

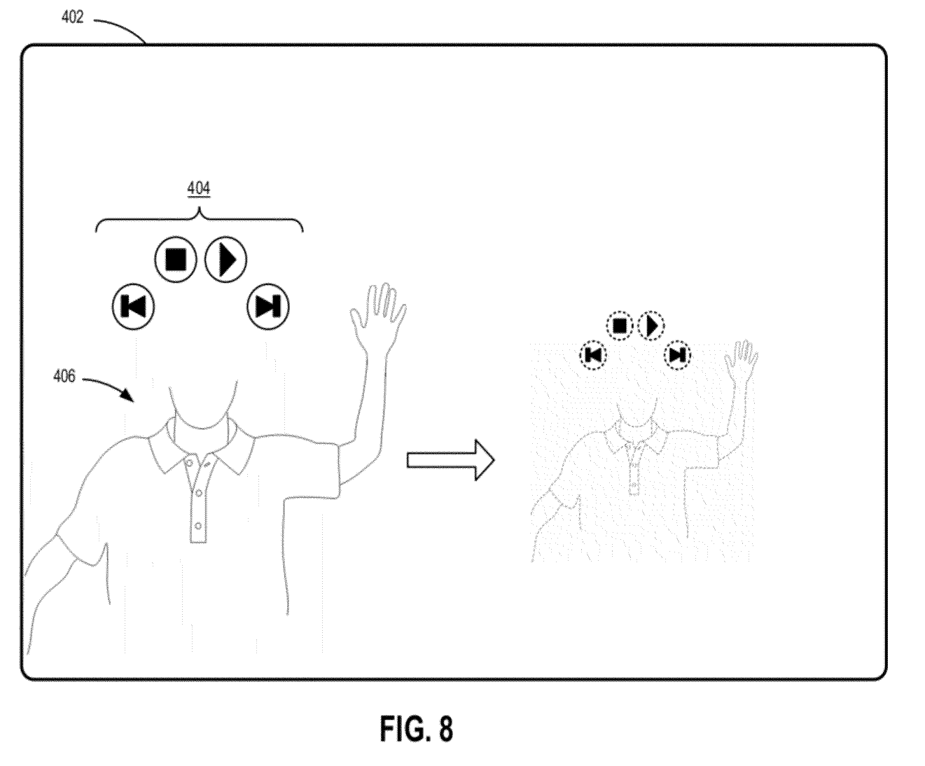

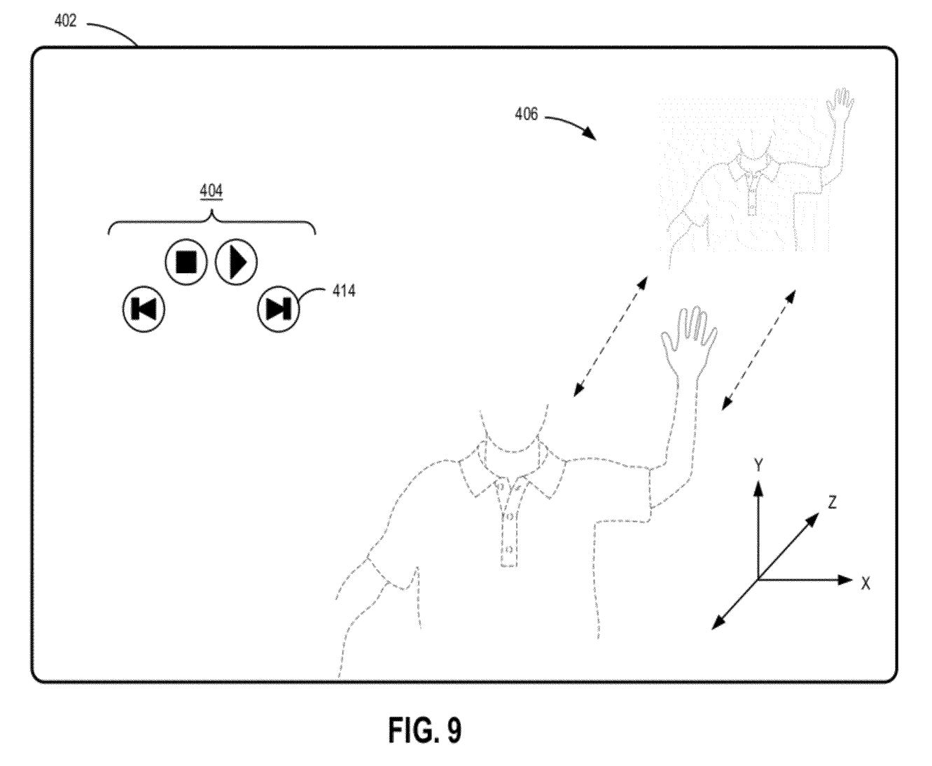

FIGS. 8 and 9 illustrate other examples of adjusting the location and/or size of controls. In these illustrations, if the user 406 moves farther away or closer to the video capture device, the controls 404 are resized accordingly. For some embodiments, if the user 406 moves farther away from the video capture device, the controls 404 become smaller. (In alternative embodiments, the controls 404 may become larger as the user 406 moves farther away to make it easier for the user 406 to view the controls 404.) In yet other embodiments, the controls 404 may simply remain the same size.

As will be described in more detail below, one embodiment, among others, is a method performed in a multimedia playback system for adaptively modifying a user interface. The method comprises receiving video content and displaying the video content, identifying playback controls displayed in conjunction with the video content, and identifying a user in a field of view of a video capture device coupled to the multimedia playback system. The method further comprises determining an initial relative position of the playback controls with respect to the user according to a first selection by the user of one of the playback controls and adjusting the playback controls according to a location of the user with respect to the video capture device such that the initial relative position is maintained.

A description of a system for adaptively updating a user interface in a multimedia playback system 102 is now described followed by a discussion of the operation of the components within the system 102. FIG. 1 is a block diagram of a multimedia playback system 102 configured to provide a user interface and receive user input. The multimedia playback system 102 may be embodied, for example, as a desktop computer, computer workstation, laptop, or other computing platform. In other embodiments, the multimedia playback system 102 may be embodied as a video gaming console 161, which includes a video game controller 162 for receiving user preferences. For such embodiments, the video gaming console 161 may be connected to a television (not shown) or other display. In other embodiments, the multimedia playback system 102 may be embodied as a smartphone 172 or a tablet 174.

The multimedia playback system 102 includes a display 104 and as well as an input devices such as a keyboard 106 and a mouse 108. The multimedia playback system 102 may also be coupled to a video capture device 110 such as a webcam for capturing images of a user of the multimedia playback system 102. When embodied as a smartphone 172 or a tablet 174, the multimedia playback system 102 may include an integrated camera for capturing video. The multimedia playback system 102 comprises a control detector 114, an object detector 116, and a user interface generator 118. The control detector 114 is configured to identify controls such as virtual playback controls that are present in a given display and analyze attributes associated with the controls. For example, the control detector may be configured to determine a relative position of the controls with respect to one or more objects. The control detector 114 is also configured to determine when controls are selected (e.g., pressed) and execute function(s) corresponding to the selected control. The object detector 116 is configured to detect the presence of one or more objects within the display area and track the motion of the identified objects. Typically, the object detector 116 detects the presence of the user controlling playback of the multimedia content 115 being viewed. In the event that more than one individual is detected by the object detector 116, the user controlling playback can be manually designated as the target object for tracking purposes. The object detector 116 can be configured to detect objects that are within a field of view of the video capture device 110. Or, the largest object among the identified objects can be designated as the target object for tracking purposes because the largest object usually corresponds to an individual closest to the video capture device 110.

The user interface generator 118 is configured to generate and update the existing user interface being displayed such that the controls detected by the control detector 114 are placed in a location proximal to the one or more objects detected by the object detector 116. Based on movement of the target object, the controls identified by the control detector 114 are adjusted by the user interface generator 118. In this regard the user interface generator 118 is configured to generate, move, and resize controls. For example, as shown in FIG. 8, the controls may be placed such that the target object (e.g., the user of the multimedia playback system 102) is centrally located among the controls in order to provide the user easy access to the controls. At the same time, the size of the controls is taken into account by the user interface generator 118 so that the controls are resized as needed.

In some scenarios, the controls in a user interface are used to play multimedia content comprising video or still images. For example, a user may wish to control playback of a movie or incorporate special effects using various special effects controls/tools. For other situations, the user may wish to zoom in/out, and crop portions of a still image. Other functions include, but are not limited to, browsing, exiting the current menu, skipping to a previous/next image, and pressing a control to initiate a slideshow. The multimedia playback system 102 is configured to receive multimedia content 115 stored on a tangible storage medium 120 such as, by way of example and without limitation, a compact disc (CD) 121, a universal serial bus (USB) flash drive 122, and an external hard drive 126. As non-limiting examples, the multimedia playback system 102 may be configured to read multimedia content 115 encoded in such formats as Digital Video Disc (DVD), Video CD (VCD), High Definition DVD (HD-DVD), BLU-RAY Disc, and China Blue High-Definition (CBHD) stored on a storage medium 121, 122, 126. Note that the multimedia content 115 may comprise such multimedia content as video titles, slideshows, and digital images.

For some embodiments, the multimedia playback system 102 may also be configured to read multimedia content from managed copies of an HD-DVD or a BLU-RAY Disc. The multimedia playback system 102 may support any one of a number of common computer interfaces, such as, but not limited to IEEE-1394 High Performance Serial Bus (Firewire), USB, a serial connection, and a parallel connection. When embodied as a tablet 174 or a smartphone 172, the multimedia playback system 102 may also be configured to receive multimedia content 115 wirelessly via a mobile phone connection. The multimedia playback system 102 may be coupled to a network (not shown), such as the Internet or a local area network (LAN). Through the network, the multimedia playback system 102 may receive multimedia content 115 from another computing system or from video sharing servers and other content providers.

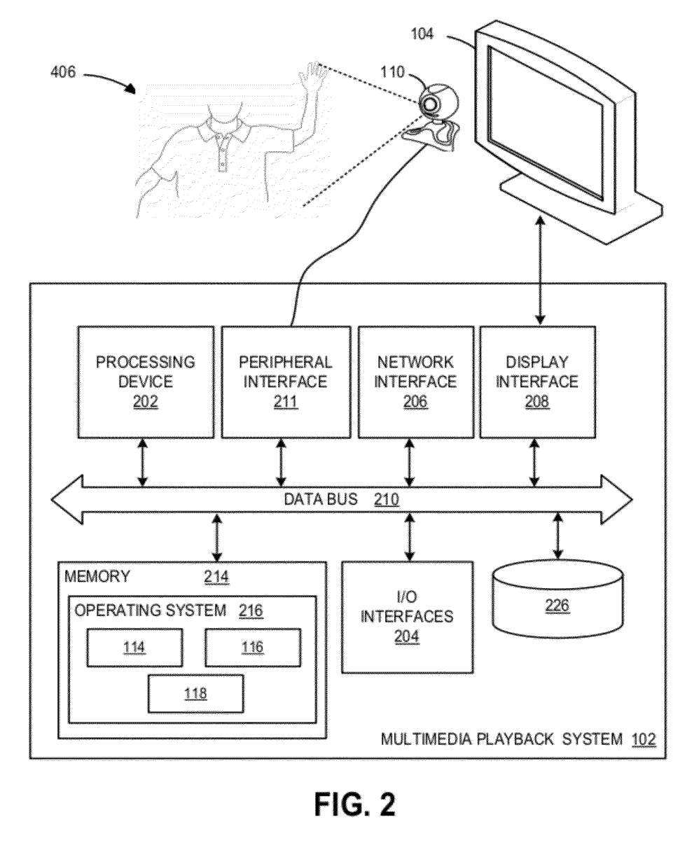

FIG. 2 illustrates an embodiment of the multimedia playback system 102 shown in FIG. 1. As discussed earlier, the multimedia playback system 102 may be embodied in any one of a wide variety of wired and/or wireless computing devices, such as a desktop computer, portable computer, a dedicated server computer, multiprocessor computing device, smart phone, personal digital assistant (PDA), tablet, and so forth. As shown in FIG. 2, the multimedia playback system 102 comprises memory 214, a processing device 202, a number of input/output interfaces 204, a display interface 208, a peripheral interface 211, network interface 206, and mass storage 226, wherein each of these devices are connected across a local data bus 210. The multimedia playback system 102 may be configured to receive multimedia content 115 (FIG. 1) via the peripheral interface 211 or an optical disc drive interface (not shown). Note, however, that the multimedia playback system 102 may also receive multimedia content 115 from the Internet via the network interface 206.

The processing device 202 may include any custom made or commercially available processor, a central processing unit (CPU) or an auxiliary processor among several processors associated with the multimedia playback system 102, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 214 can include any one of a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216, one or more native applications, emulation systems, or emulated applications for any of a variety of operating systems and/or emulated hardware platforms, emulated operating systems, etc. For example, the applications may include application specific software which may comprise some or all the components 114, 116, 118 of the multimedia playback system 102 depicted in FIG. 1. In accordance with such embodiments, the components 114, 116, 118 are stored in memory 214 and executed by the processing device 202. One of ordinary skill in the art will appreciate that the memory 214 can, and typically will, comprise other components which have been omitted for purposes of brevity.

Input/output interfaces 204 provide any number of interfaces for the input and output of data. For example, where the multimedia playback system 102 is embodied as a personal computer, these components may interface with one or more user input devices, which may comprise a keyboard 106 or a mouse 108, as shown in FIG. 1. The display 104 may comprise a computer monitor, a liquid crystal display (LCD) or other display device. While a mouse 108 and/or keyboard 106 may be used to navigate the user interface provided by the user interface generator 118 (FIG. 1), a display 104 that provides touch screen functionality may also be incorporated as part of the multimedia playback system 102.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

As shown in FIG. 2, a video capture device 110 such as a webcam is coupled to the multimedia playback system 102 via a cable attached to the peripheral interface 211 of the multimedia playback system 102. The video capture device 110 captures images of a user 406. Based on the captured video, a set of virtual controls shown on the display 104 can be controlled by the user 406. The multimedia playback system 102 interprets certain motions by the user 406 (e.g., a tapping motion) as invoking onscreen commands shown on the display 104. As will be described in more detail below, the components 114, 116, 118 in the multimedia playback system 102 are configured to adaptively place controls based on the location of the user 406.

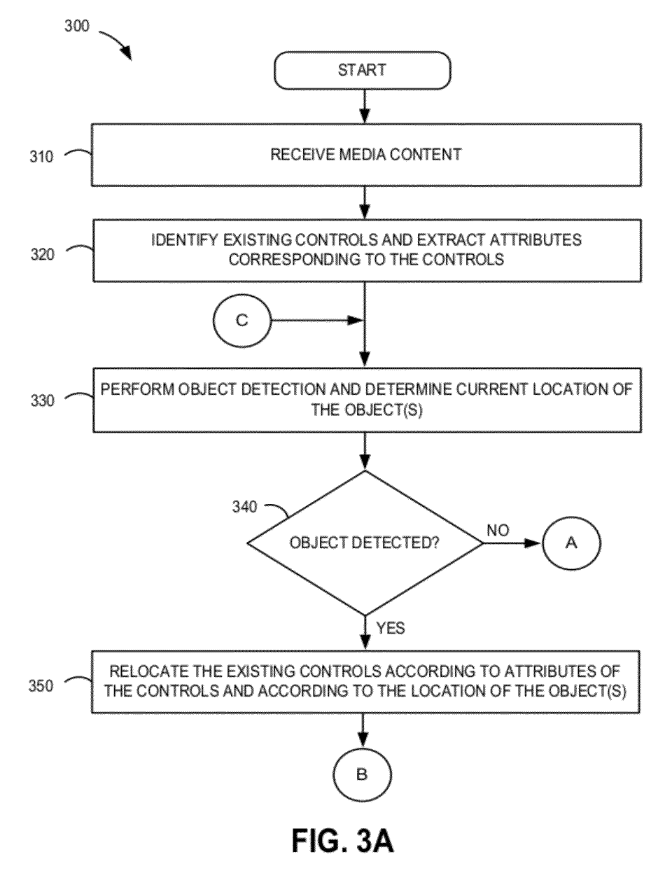

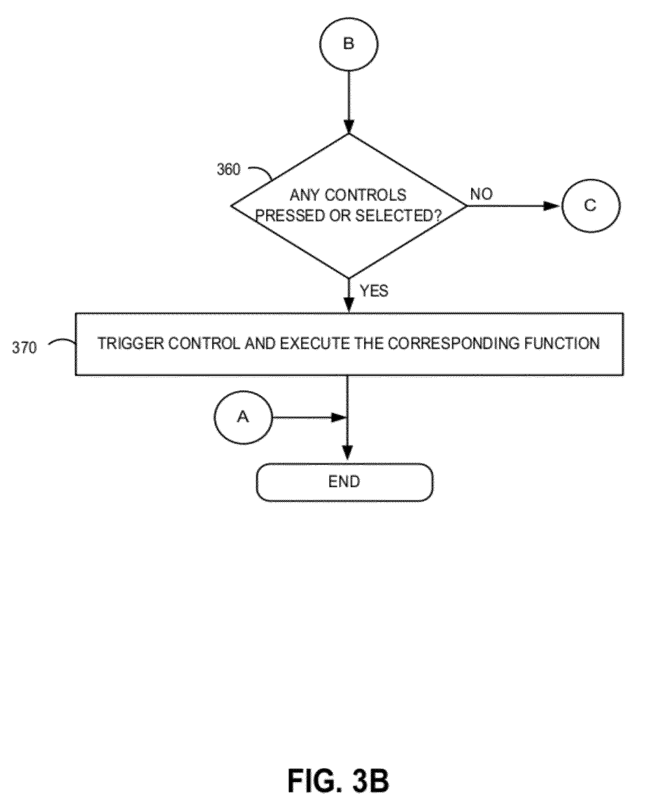

Reference is now made to FIGS. 3A-B, which depict a flowchart 300 for a method for adaptively updating a user interface performed by the multimedia playback system 102 of FIG. 1. If embodied in software, each block depicted in FIG. 3 represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as a processor in a computer system or other system such as the one shown in FIG. 1. The machine code may be converted from the source code, etc. If embodied in hardware, each block may represent a circuit or a number of interconnected circuits to implement the specified logical function(s).

Although the flowchart 300 of FIGS. 3A-B shows a specific order of execution, it is understood that the order of execution may differ from that which is depicted. In block 310, multimedia content 115 is received by the multimedia playback system 102 shown in FIG. 1. As described earlier, the multimedia content 115 may comprise video content and/or still images to be processed by the multimedia playback system 102. If the multimedia content 115 comprises video, the multimedia playback system 102 processes the video on a frame-by-frame basis to determine movement of the object(s) within the frames.

In block 320, the control detector 114 of FIG. 1 identifies existing controls and tools within the display 104 of the multimedia playback system 102 and extracts attributes associated with the controls/tools. For example, the size and relative spacing of each control/tool is determined. The controls and tools may be launched by the user 406 or may be automatically displayed when multimedia content 115 is received. By way of illustration, an application executed by the multimedia playback system 102 may be configured to automatically launch a panel of drawing tools on the display 104 when a still image is received by the multimedia playback system 102. The control detector 114 determines which controls are present within the display 104.

In block 330, the object detector 116 of FIG. 1 detects the one or more objects captured by the video capture device 110 shown in FIGS. 1 and 2. For example, a user 406 situated in front of a video capture device 110 is identified by the object detector 116. The object detector 116 determines the current location of the one or more objects. Note here that the object may be predefined as either the entire user or just a portion of the user 406 (or any other object within the field of view of the video capture device 110). To illustrate, reference is made to the example in FIG. 4. For some implementations, the object detector 116 may be configured to monitor the movement of the user 406 as a whole, such that if the user 406 remains stationary, the controls 404 are not relocated. In other implementations, however, the object detector 116 may be configured to monitor for any movement (for example, a hand waving motion by the user 406). In this scenario, the object detector 116 flags this as movement of the object (i.e, the user's hand). Referring back to FIG. 3A, the detection operation performed in block 330 may comprise, for example, determining whether the object is hidden from view or outside the field of view of the video capture device 110. The detection operation may also detect whether there is no movement within the field of view of the video capture device 110. Under these scenarios, no object is detected.

At decision block 340, a determination is made on an object was detected in block 330. If an object was detected then the method proceeds to block 350, where the existing controls are relocated according to attributes of the controls and according to the location of the detected object(s). If no object was detected in block 330, then processing ends. At decision block 360 (FIG. 3B), a determination is made on whether any of the controls are pressed or selected by the user. If a control is pressed or selected, then in block 370, the control is triggered and the function(s) corresponding to the control is executed. For example, with reference back to FIG. 4, if the user 406 taps on the skip forward control 414, the control 414 is triggered (e.g., highlighted) and playback of the video content 115 skips forward. Referring back to decision block 360 in FIG. 3B, if no controls are pressed or selected, then the method proceeds back to block 330 (FIG. 3A).

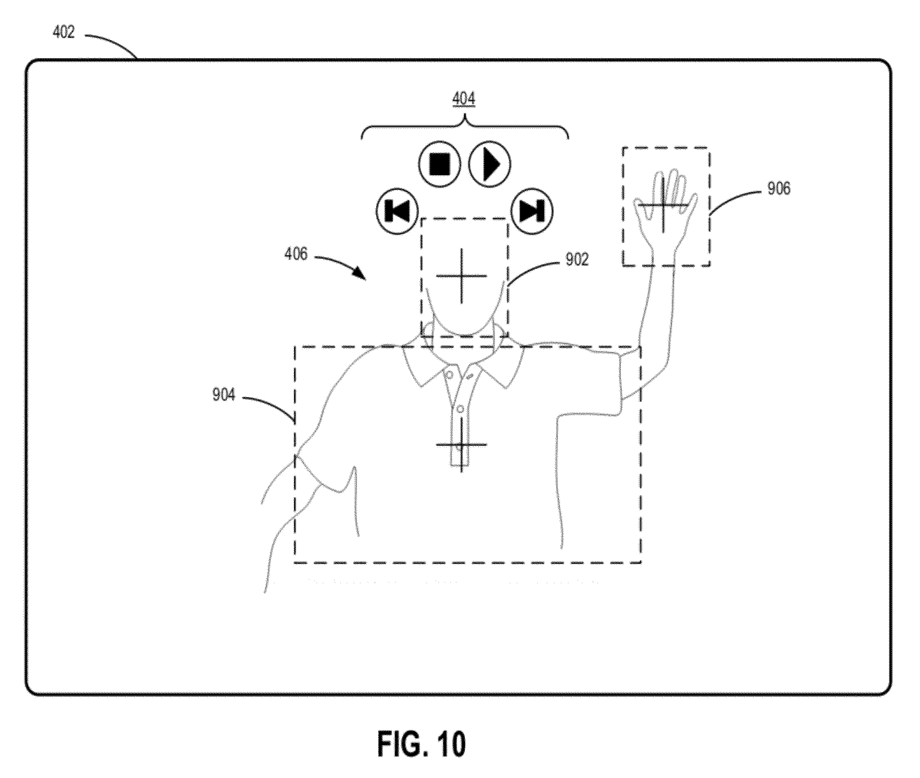

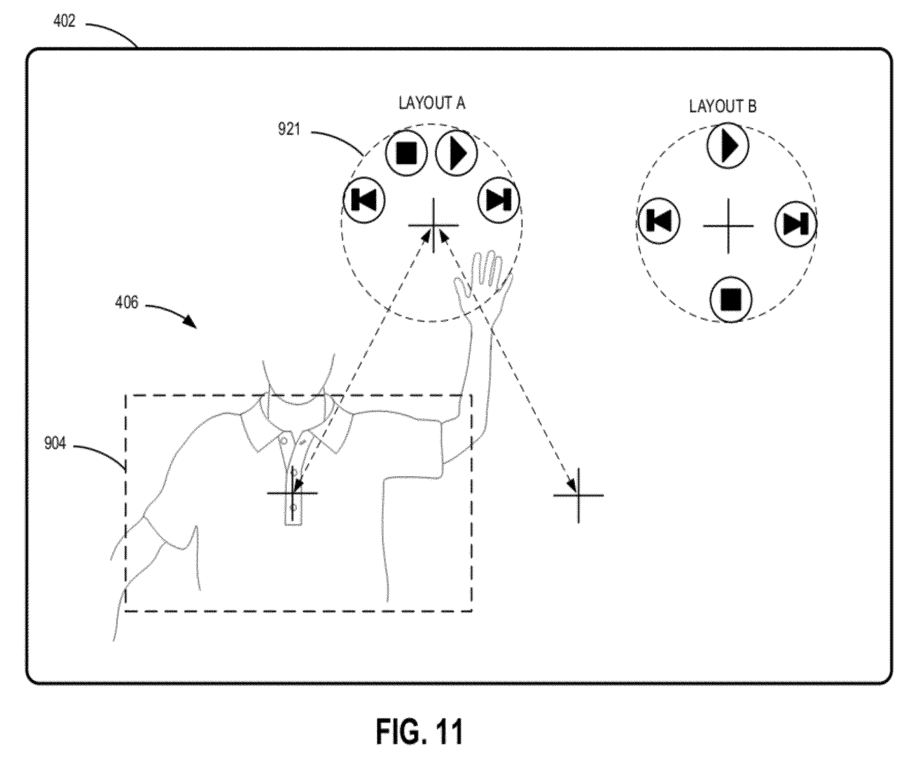

FIG. 10 illustrates the calculation of a relative distance between onscreen controls 404 and the user 406. The distance between the controls 404 and the user 406 can be calculated using various techniques. One technique focuses on the facial region 902 of the user 406 whereby the distance between the center of the facial region 902 and the controls 404 is calculated. Referring briefly to FIG. 11, the center of a boundary 921 encompassing all the controls can be used as a reference point for measuring the distance. The layout of the controls can, of course, vary. The use of a boundary 921 is just one of many reference points on the controls 404 that can be used. Referring back to FIG. 10, other attributes of the user 406 can also be used to track the movement of the user 406. As shown, the torso region 904 of the user 406 can be used. The user's hand 906 can also be used as a reference point.

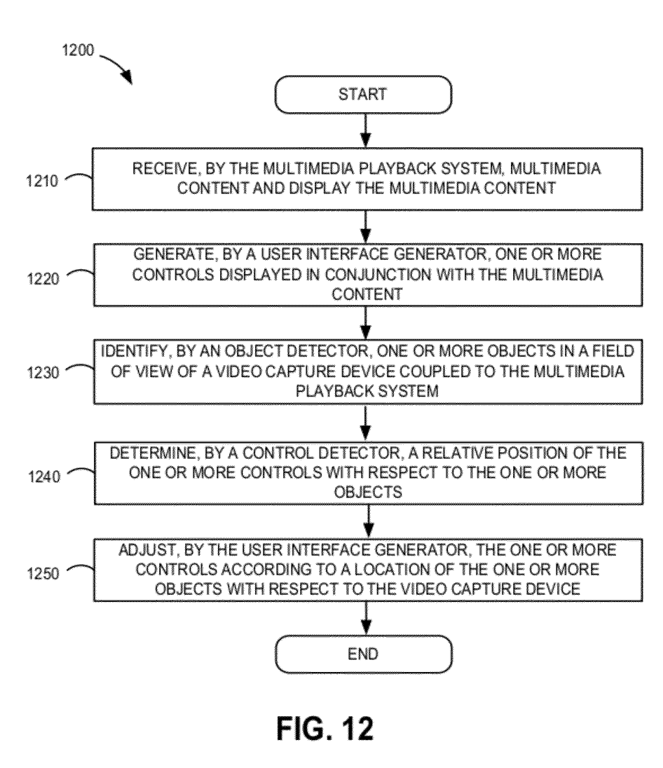

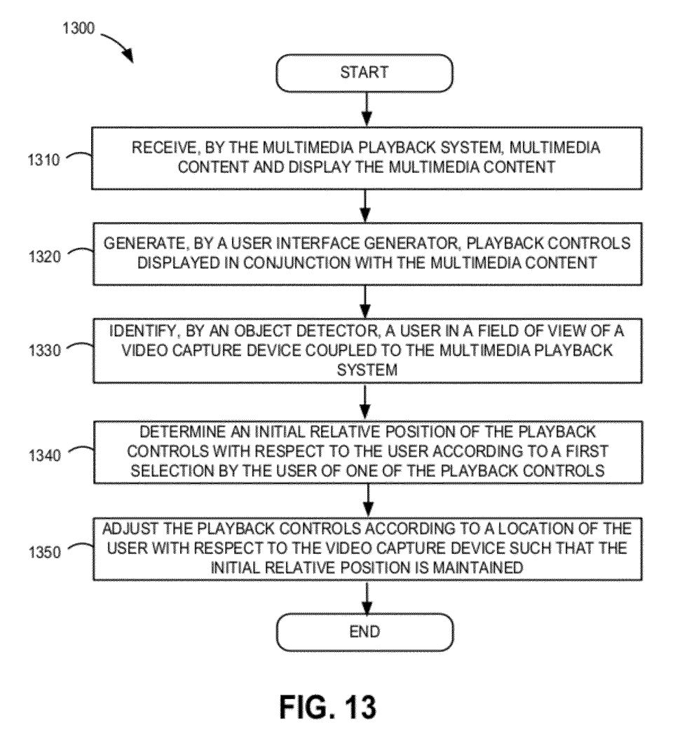

FIGS. 12 and 13 depict methods in accordance with various embodiments performed in the multimedia playback system 102 of FIG. 1 for adaptively modifying a user interface. As with the method in FIG. 3, if embodied in software, each block depicted in FIGS. 12 and 13 represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as a processor in a computer system or other system such as the one shown in FIG. 1. The machine code may be converted from the source code, etc. If embodied in hardware, each block may represent a circuit or a number of interconnected circuits to implement the specified logical function(s).

Although the flowcharts 1200, 1300 of FIGS. 12 and 13 show a specific order of execution, it is understood that the order of execution may differ from that which is depicted. In block 1210, the multimedia playback system 102 of FIG. 1 receives multimedia content 115 and displays the multimedia content 115. In block 1220 the user interface generator 118 generates one or more controls that are displayed in conjunction with the multimedia content 115. In block 1230, the object detector 116 detects one or more objects in a field of view of a video capture device 110 coupled to the multimedia playback system 102. In block 1240, the control detector 114 determines a relative position of one or more controls with respect to the one or more objects. In block 1250, the user interface generator 118 adjusts the one or more controls according to a location of the one or more objects with respect to the video capture device 110. Preferably, the one or more controls are generated in response to identifying the one or more objects, wherein the one or more controls can also be generated in a default location if no objects are identified. And, the target object can be identified by identifying an area within the field of view of the video capture device 110 that substantially matches a target color, such as a skin color.

Referring to the flowchart 1300 in FIG. 13, in block 1310, the multimedia playback system 102 of FIG. 1 receives multimedia content 115 and displays the multimedia content 115. In block 1320, the user interface generator 118 generates playback controls that are displayed in conjunction with the multimedia content 115. In block 1330, the object detector 116 identifies a user 406 (see FIG. 4) in a field of view of a video capture device 110 coupled to the multimedia playback system 102 (see FIG. 1). In block 1340, an initial relative position of the playback controls 404 (FIG. 4) is determined with respect to the user 406 according to a first selection by the user 406 of one of the playback controls 404.

The initial relative position may be defined in various ways. For some embodiments, the user 406 manually specifies to the multimedia playback system 102 that the current position of the user 406 should be used for calculating the distance to the controls. In other embodiments, the initial relative distance is calculated the first time the user 406 invokes or selects one of the controls 404 as it is assumed that the user 406 is able to conveniently access the controls 404. In block 1350, the playback controls 404 are adjusted according to a location of the user 406 with respect to the video capture device 110 such that the initial relative position is maintained. The adjustment of the playback controls 404 may comprise, for example, relocating and/or resizing the playback controls 404 in accordance with the techniques described earlier.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

At least the following is claimed:

1. A method performed in a multimedia playback system for adaptively modifying a user interface, comprising:
receiving, by the multimedia playback system, multimedia content and displaying the multimedia content;
generating, by a user interface generator, one or more controls displayed in conjunction with the multimedia content;
identifying, by an object detector, one or more objects in a field of view of a video capture device coupled to the multimedia playback system;
determining, by a control detector, a relative position of the one or more controls with respect to the one or more objects; and
adjusting, by the user interface generator, the one or more controls according to a location of the one or more objects with respect to the video capture device.

2. The method of claim 1, further comprising the user interface generator generating the one or more controls in a default location if no objects are identified.

3. The method of claim 1, wherein generating one or more controls is performed in response to identifying one or more objects.

4. The method of claim 1, wherein adjusting the one or more controls is performed in response to detecting motion by the one or more objects.

5. The method of claim 1, further comprising hiding the controls on the user interface if one or more previously-identified objects disappear from the field of view for a predetermined amount of time.

6. The method of claim 1, further comprising adjusting the one or more controls according to a location associated with one or more previously-identified objects if no objects are currently identified.

7. The method of claim 1, further comprising hiding the controls from the user interface if one or more previously-identified objects remain stationary for a predetermined amount of time.

8. The method of claim 7, wherein hiding the controls from the user interface is not performed if the one or more previously-identified object remains stationary and is located above one or more of the controls.

9. The method of claim 1, wherein the one or more objects comprises one or more of:
a facial region of a user of the multimedia playback system;
a torso region of the user of the multimedia playback system; and
a hand region of the user of the multimedia playback system, the hand being used to make selections among the one or more controls.

10. The method of claim 1, wherein identifying one or more objects comprises:
identifying a facial region of a user of the multimedia playback system for determining the location of the user; and
identifying a hand region of the user of the multimedia playback system for making selections among the one or more controls.

11. The method of claim 1, further comprising upon detecting a plurality of objects, the step of adjusting the one or more controls is performed according to a location of a largest object among the identified objects with respect to the video capture device, wherein each of the plurality of objects corresponds to a different individual, wherein the largest object among the identified objects corresponds to an individual closest to the video capture device.

12. The method of claim 1, wherein adjusting the one or more controls comprises moving all of the one or more controls such that the determined relative position of the one or more controls with respect to the one or more objects is approximately constant.

13. The method of claim 1, further comprising determining a relative size of the one or more controls with respect to size of the one or more objects, wherein adjusting the one or more controls comprises resizing all the one or more controls such that the determined relative size of the one or more controls with respect to the size of the one or more objects is approximately constant.

14. The method of claim 1, wherein determining a relative position of the one or more controls with respect to the one or more objects comprises determining a relative position of all of the one or more controls with respect to a center of a facial region corresponding to one of the one or more objects.

15. The method of claim 1, wherein determining a relative position of the one or more controls with respect to the one or more objects comprises determining a relative position of a center of a boundary encompassing all of the one or more controls with respect to the one or more objects.

16. The method of claim 1, wherein identifying a target object comprises identifying an area within the field of view of the video capture device that substantially matches a target color.

17. A multimedia playback system configured to adaptively modify a user interface, comprising:
a user interface generator configured to generate one or more controls displayed in conjunction with a multimedia content displayed by the multimedia playback system;
an object detector configured to identify one or more objects of the multimedia playback system, the object being in a field of view of a video capture device coupled to the multimedia playback system; and
a control detector configured to determine a relative position of the one or more controls with respect to the one or more objects;
wherein the user interface generator adjusts the one or more controls according to a location of the object with respect to the video capture device.

18. The system of claim 17, wherein the user interface generator is further configured to receive input from the user with respect to one of the generated one or more controls, the control detector interpreting the input as one of an enable state and a disable state, and wherein if an enable state is interpreted by the control detector, the control detector executes a function associated with one control.

19. The system of claim 17, wherein the object detector identifies one or more objects by:
identifying a facial region of a user of the multimedia playback system for determining the location of the user; and
identifying a hand region of the user of the multimedia playback system for making selections among the one or more controls.

20. The system of claim 17, wherein the user interface generator adjusts the one or more controls according to a location of the one or more objects with respect to the video capture device by performing one or more of:
relocating the one or more controls; and
resizing the one or more controls.

21. The system of claim 17, wherein the user interface generator adjusts the one or more controls such that an initial relative distance between the one or more objects and the one or more controls is maintained.

22. The system of claim 21, wherein initial relative distance is defined by a user of the multimedia playback system.

23. A method performed in a multimedia playback system for adaptively modifying a user interface, comprising:
receiving, by the multimedia playback system, multimedia content and displaying the multimedia content;
generating, by a user interface generator, playback controls displayed in conjunction with the multimedia content;
identifying, by an object detector, a user in a field of view of a video capture device coupled to the multimedia playback system;
determining an initial relative position of the playback controls with respect to the user according to a first selection by the user of one of the playback controls; and
adjusting the playback controls according to a location of the user with respect to the video capture device such that the initial relative position is maintained.

24. The method of claim 23, further comprising determining an initial relative size of each of the playback controls with respect to a size of the user according to a first selection by the user of one of the playback controls.

25. The method of claim 24, further comprising adjusting the size of each of the playback controls according to the size of the user with respect to the video capture device such that the initial relative size is maintained.

26. The method of claim 25, wherein adjusting the size of each of the playback controls according to the size of the user is performed according to an inverse relationship such that the size of each of the playback controls increases as a size of the user decreases.
